(19) United States
(12) Patent Application Publication
(10) Pub. No.: US 2011/0320112 A1
(43) Pub. Date: Dec. 29, 2011

(54) SOLAR OR WIND POWERED TRAFFIC MONITORING DEVICE AND METHOD

(75) Inventor: LAWRENCE E. ANDERSON, ARLINGTON, VA (US)

(73) Assignee: LAWRENCE ANDERSON, ARLINGTON, VA (US)

(21) Appl. No.: 13/214,202

(22) Filed: Aug. 21, 2011

Related U.S. Application Data
(63) Continuation-in-part of application No. 13/189,505, filed on Jul. 23, 2011.
Application No. 13/189,505 is a continuation-in-part of application No. 13/155,331, filed on Jun. 7, 2011.
Application No. 13/155,331 is a continuation of application No. 12/860,876, filed on Aug. 21, 2010, now Pat. No. 7,954,977.
Application No. 12/860,876 is a continuation of application No. 12/462,555, filed on Aug. 5, 2009, now Pat. No. 7,789,524.

(51) Int. Cl. G08G 1/00; G01C 21/34

(52) U.S. Cl. 701/119

(57) ABSTRACT

A system for monitoring the flow of vehicular traffic comprising: a plurality of detectors that detect the passage of a vehicle along a predetermined roadway; the detectors being powered by one of solar or wind power; at least one transmitter for transmitting the data relating to the passage of a vehicle at a predetermined point on a roadway; the transmitter being powered by solar or wind power; and a second receiver for receiving the transmitted data relating to the passage of a vehicle along a predetermined roadway for use by a motorist in determining a route of travel. A method for monitoring the flow of vehicular traffic for purposes of determining a route of travel for motorists comprising: determining traffic speed at least one point along a roadway using a plurality of detectors that detect the passage of a vehicle; the detectors being powered by one of solar or wind power, and transmitting the traffic speed using at least one solar powered transmitter for use by motorists in determining whether or not to select passage along the roadway containing the at least one point as a way to navigate through the region.

### CROSS REFERENCE TO RELATED APPLICATIONS

This application is a continuation-in-part and claims priority to application Ser. No. 13/189,505, entitled “Traffic Monitoring Device and Method” filed Jul. 23, 2011 (hereby incorporated by reference). This application claims priority and is a continuation in part of U.S. Application No. 13/155331 entitled Photovoltaic Cell and LED Assembly and Method of Making filed Jun. 7, 2011 (hereby incorporated by reference) which claims priority to U.S. application Ser. No. 12/860,876 entitled “Electrical Assembly” filed Aug. 21, 2010 (now U.S. Pat. No. 7,954,977, through which priority is claimed to U.S. Pat. No. 7,789,524, filed Aug. 5, 2009, entitled Solar or Wind Powered Light, which issued as a patent on Sep. 7, 2010.

### BACKGROUND OF THE INVENTION

It is known in the prior art to tune into a radio station for a periodic traffic report. However, a person is in his or her car about to enter a congested limited access highway, it is highly unlikely that a traffic broadcast will be occurring at that time. Yet when vehicles are slowed down by traffic jams, previously occurring accidents, or construction work, energy is wasted as vehicles wait idly for the traffic congestion to clear.

For most commutes to and from work, people generally travel the same route every work day. However, whether their commute will be bumper to bumper traffic or a speedy ride home is largely unknown. When traffic slows to a stand-still, energy is wasted as cars and trucks idle unnecessarily. In an age when energy consumption is a national concern, devices which promote traffic flow are in large demand.

Disclosed as TIRTL, the infra-traffic-logger uses infra-red cones sent from a transmitter to a receiver situated on opposite sides of the road perpendicular to the flow of traffic. The system may be problematic in that positioning on the side of the road is subject to being struck by an out of control motorist or tampering. Moreover, measurements of one car in one lane with signals being received across a roadway are subject to interference from other cars crossing in the path of the signal transmitted by the TIRTL.

Positioning on the road side may be an attempt to eliminate overhead background interference from sunlight, which also contains infrared emission. Attempts to operate outside of the solar spectrum have been documented. In an article entitled “Solar-blind avalanche photodiodes,” by Ryan McClintock, et al., Northwestern University; Quantum Sensing and Nanophotonic Devices III, pros. of SPIE Vol. 6127, 61271D-7, (2006) (hereby incorporated by reference), operation at 289 nm within the solar-blind region of the ultraviolet spectrum is disclosed for a photomultiplier. According to the article, the solar blind region corresponds to the strong atmospheric absorption of solar UV at wavelengths less than 290 nm. This creates a natural low background window for detection of man-made 13V sources.

By way of background, according to Wikipedia, the Global Positioning Satellite (GPS) receiver uses the messages it receives to determine the transit time of each message and computes the distance to each satellite. These distances along with the satellites' locations are used with the possible aid of trilateration, depending on which algorithm is used, to compute the position of the receiver. This position is then displayed, perhaps with a moving map display or latitude and longitude; elevation information may be included. Many GPS units show derived information such as direction and speed, calculated from position changes.

According to Wikipedia, a GPS receiver is able to determine the times sent and then the satellite positions corresponding to these times sent. The x, y, and z components of position, and the time sent, are designated as [xᵢ, yᵢ, zᵢ, tᵢ] where the subscript i is the satellite number and has the value 1, 2, 3, or 4. Knowing the indicated time the message was received tᵣ, the GPS receiver can compute the transit time of the message as (tᵣ−tᵢ). Assuming the message traveled at the speed of light, c, the distance traveled or pseudorange, pᵢ can be computed as (tᵣ−tᵢ)c. A satellite's position and pseudorange define a sphere, centered on the satellite, with radius equal to the pseudorange.

Further according to Wikipedia, with four satellites, the indicated position of the GPS receiver is at or near the intersection of the surfaces of four spheres. In the ideal case of no errors, the GPS receiver would be at a precise intersection of the four surfaces. The current GPS consists of three major segments. These are the space segment (SS), a control segment (CS), and a user segment (U.S.), The U.S. Air Force develops, maintains, and operates the space and control segments. GPS satellites broadcast signals from space, and each GPS receiver uses these signals to calculate its three-dimensional location (latitude, longitude, and altitude) and the current time. The control segment is composed of a master control station, an alternate master control station, and a host of dedicated and shared ground antennas and monitor stations. The user segment is composed of hundreds of thousands of U.S. and allied military users of the secure GPS Precise Positioning Service, and tens of millions of civil, commercial, and scientific users of the Standard Positioning Service. The user segment is composed of hundreds of thousands of U.S. and allied military users of the secure GPS Precise Positioning Service, and tens of millions of civil, commercial and scientific users of the Standard Positioning Service. In general, GPS receivers are composed of an antenna, tuned to the frequencies transmitted by the satellites, receiver-processors, and a highly stable clock (often a crystal oscillator). They may also include a display for providing location and speed information to the user.

Wikipedia further discloses vehicle tracking as follows:
A vehicle tracking system combines the installation of an electronic device in a vehicle, or fleet of vehicles, with purpose-designed computer software at least at one operational base to enable the owner or a third party to track the vehicle's location, collecting data in the process from the field and deliver it to the base of operation. Modern vehicle tracking systems commonly use GPS or GLONASS technology for locating the vehicle, but other types of automatic vehicle location technology can also be used. Vehicle information can be viewed on electronic maps via the Internet or specialized software. Urban public transit authorities are an increasingly common user of vehicle tracking systems, particularly in large cities. VETRAC, is a wireless enabled vehicle tracking system, implemented by Net Research Labs for Indian urban city scenario.

### SUMMARY OF THE PRESENT INVENTION

Preferred embodiments are directed to a method and/or system monitoring of traffic. The method and/or system may use set radio frequencies for localized traffic reporting, Global Positioning Systems (GPS) and/or traffic signs.

A preferred embodiment comprises a system for detecting the flow or speed of traffic on highways using monitors to monitor vehicular traffic based upon travel of motorists on a predetermined roadway.

A preferred embodiment may comprise the apparatus associated with speed detection or radar to monitor traffic flow. For example, radio station AM 650 may be devoted to the traffic reporting for a major highway, such as the north of the Beltway surrounding Washington D.C. Speed of traffic can be obtained via radar and relayed by electronic means, such as for example, a radio transmission indicating speed at mile marker 20 is currently 50 MPH. In the case of an accident or obstruction, radio station AM 650 could report traffic flow below average or average vehicle speed may be, for example, 5 MPH. A series of monitors may report speed at various increments along the roadway, such as “traffic speed 40 MPH at mile marker 20” traffic speed 5 MPH at mile marker 30” “traffic speed 50 MPH at mile marker 40.” Thus, one can then make the determination that there is likely an accident between mile marker 30 and mile marker 40. Using this information, one can make the decision to exit the highway at mile marker 20 and return at mile marker 40, thereby bypassing the slowed traffic. In addition, vocal message may be left by fellow motorist, local government employees or police personnel at AM 650. Using such a technique, the motorist will know the speed of the vehicular traffic before entering the highway so that an educated decision can be made whether or not to enter.

Moreover, since the information broadcasted at a radio frequency, such as AM 650, is of a local nature, the radio broadcast may be from a local transmitter of limited range. When in the area of mile marker 20, the radio broadcast on AM 650 would be devoted to the area in the vicinity of mile markers 20 to 40. When in the area of mile markers 40 to 60. AM 650 would contain information relating to that area. Moreover, for easterly traffic, a given station may be used while for westerly traffic, AM 670 could be utilized.

A preferred embodiment may comprise an interconnection with a GPS system. Depending upon the traffic flow, the GPS system could be set to route traffic to maximize time of travel. In a case involving the northern part of the beltway, for example, a route encompassing the northern part of the beltway may depend on the flow of traffic on the northern part. As an option, traffic speed could be monitored at street level and relayed to the satellites embodying the GPS system or to other satellites. The GPS system could then incorporate traffic speed when determining routing. As a further option, individual units in motorist's cars could integrate the vehicle speed data with GPS data to determine the motorist route of travel.

In one preferred embodiment traffic flow could be monitored using foot print type sensors to detect the front and back tires striking sensors. A lane could be reserved for cars only and passed upon the sensor imprint or actuation, speed of the car could be determined. That is, two sensors spaced a given distance apart could determine car speed or average car speed.

A preferred embodiment comprises a system for monitoring the flow of vehicular traffic comprising at least one first transmitter receiver that detects the passage of a vehicle; at least one second transmitter for transmitting the data relating to the passage of a vehicle at a predetermined point on a roadway for use by motorists in determining a route of travel. The system may comprise a plurality of first transmitter receivers (or detectors) spaced at intervals along a roadway for detecting the speed of a vehicles passing in the vicinity of the first transmitter receivers. The transmitter receivers (detectors) may be radar or may operate in the solar blind region. The transmitter/receivers may be which are spaced apart at intervals along a highway or roadway, such as for example, every mile or within each section of a limited access highway, so that motorists may become aware of traffic conditions on the road ahead and exit the limited access highway based upon the information relayed at an exit preceding the point in the limited access highway. The information obtained by the radar or solar blind region transmitter/receivers may be relayed to motorists navigating in the nearby region.

In a preferred embodiment, optionally the transmitters may transmit the traffic and vehicle information to a GPS receiver or receivers so as to enable use of the traffic information in conjunction with a GPS device. The GPS receiver may then determine the optimum suggested route for navigation based upon the average traffic speeds at the recorded points on a roadway or roadways. In addition, or in the alternative, the transmitter may transmit (or broadcast) the vehicle speed information and traffic flow data at a radio frequency for reception by a motorist in the vicinity of the second transmitter. To accommodate many such stations on a limited frequency band, the signal strength of the radio transmission may be selected to be localized so that reception is limited to motorists traveling in the local region. Accordingly, the same frequency or similar frequencies could be used at different locations.

An additional option is to operatively connect a transmitter which transmits the traffic monitoring data to a display for displaying traffic speeds at points along a roadway.

A preferred embodiment may further comprise a first processor operatively connected to the transmitter receivers such that the first processor operates to determine an average speed for vehicles at a predetermined point in the roadway. The first processor may be operatively associated with a second transmitter that transmits average speed data to one or more of GPS device, a radio broadcaster system, and/or a display for vehicles positioned along the same highway at a position prior to the predetermined point so that a vehicle approaching the predetermined point on the given roadway will have an option to take an alternate route depending upon the data reported. The second transmitter may transmit to a second receiver which is located at a point remote from the predetermined point and wherein the second receiver is operatively connected to a second processor which determines average traffic speed at intervals along a roadway, the second processor being operatively connected to one of a GPS system, radio transmission, or display in the vicinity of the roadway having the predetermined point thereon.

A preferred methodology comprises a method for monitoring the flow of vehicular traffic for purposes of determining a route of travel for motorists comprising determining traffic speed at least one point along a roadway using at least one first transmitter receiver that detects the passage of a vehicle; and transmitting the traffic speed using at least one second transmitter for use by motorists in determining whether or not to select passage along the roadway containing the at least one point as a way to navigate through the region.

### BRIEF DESCRIPTION OF THE DRAWINGS

These and/or other aspects and advantages of the invention will become apparent and more readily appreciated from the following description of the embodiments, taken in conjunction with the accompanying drawings of which: The drawings of this invention are illustrative and diagrammatic in nature in order to present the principles of the invention. They are being provided as examples without limiting the invention to the specific configuration or dimensions shown.

FIG. 1A is a schematic illustration of a preferred embodiment traffic monitoring system comprising an overhead transmitter and ground based sensor or reflector.

FIG. 1B is a schematic illustration of an alternate preferred embodiment traffic monitoring system comprising a combined overhead transmitter and sensor 11R/T.

FIG. 1C is a schematic illustration from an overhead view of a preferred embodiment traffic monitoring system comprising an array of overhead receiver/transmitters 11.

FIG. 2 is a schematic illustration of the preferred embodiment of FIG. 1 taken along the lines 2-2 of FIG. 1.

FIG. 3 is a schematic illustration of an alternate preferred embodiment comprising ground based sensors 12A with roll-over detector strips 12B.

FIG. 4 is a schematic illustration of a preferred embodiment electrical circuitry diagram wherein the sensors 12 are electrically connected to a processor 13.

FIG. 5 is a schematic illustration a plurality of traffic monitoring devices 10 operatively connected to a receiver 14 and processor 15 for display 16, GPS trip calculation 17 and/or radio 18.

FIG. 6A is a schematic illustration of a plurality of traffic monitoring devices 10 using radar transmitters/receivers operatively connected to a receiver 14 and processor 15 for display 16, GPS trip calculation 17 and/or radio 18.

FIG. 6B is a schematic drawing of a solar powered radio transmitter for use with the embodiment of FIGS. 5, 6A, 15A, and/or 16.

FIG. 6C 22 is a schematic circuit 70A diagram of a preferred embodiment of the present invention without optional temperature sensor.

FIG. 7 is an illustration of an example of a GPS trip calculation scenario.

FIG. 8 is another illustration of an example of a GPS trip calculation scenario.

FIG. 9 is an illustration diagramming and/or outlining an example of a radio announcement for a scenario involving traffic on an arbitrarily selected route I-495.

FIG. 10 is an illustration depicting a map of an example of a corridor in which alternate routes are available, including two limited access highways.

FIG. 11 is an illustration of a GPS trip calculation scenario for the area depicted in the map illustration of FIG. 10.

FIG. 12 is an illustration of a diagram of a radio announcement sequence for the area depicted in the map illustration of FIG. 10.

FIG. 13 is an illustration of the mapped area of FIG. 10 showing possible placement of traffic monitoring devices D/T 10, which may be the systems of FIG. 1, FIG. 2, FIG. 3, FIG. 4, FIG. 5, and/or FIG. 6.

FIG. 14 is an illustration depicting the sequencing of transmissions from the devices D/T 10 of FIG. 13.

FIG. 15A is a schematic illustration of a preferred embodiment using transmitter/receivers 11R/T.

FIG. 15B is an overhead view of FIG. 15A.

FIG. 16 is a schematic illustration schematic illustration of a plurality of traffic monitoring devices using transmitters/receivers operatively connected to a receiver 14 and processor 15 for display 16, GPS trip calculation 17, cell phone service and/or radio 18.

FIG. 17 is an illustration showing a side view of a preferred embodiment assembly 50A of the present invention comprising solar panels support 52, LED support 53, central portion 54, cover 55, wind direction detector 57, and motor/generator 59.

FIG. 18 is an illustration of another preferred embodiment assembly 50B wherein the vanes 56 are located between the solar support 52 and LED support 53 to increase cooling.

FIG. 19 is an illustration showing a cut-away view of the solar panels 52 and support 53, and vanes 56 of the preferred embodiment of the present invention shown in FIG. 18.

FIG. 20 is an illustration from an overhead perspective of the assembly of FIG. 17 showing the orientation of cover 55 responsive to a wind direction from the right to the left of the page.

FIG. 21 is a side view illustration of the preferred embodiment of FIG. 17 which has the optional capability of tilting at an angle to gain maximum exposure to the sun.

FIG. 22 is a schematic circuit 70A diagram of a preferred embodiment of the present invention with optional temperature sensor.

FIG. 23 is a schematic circuit 70B diagram showing the optional controller with control lines represented by dashed lines.

### DETAILED DESCRIPTION OF PREFERRED EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout the description of the figures.

It will be understood that when an element is referred to as being “on” another element, it can be directly on the other element or intervening elements may be present. In contrast, when an element is referred to as being “directly on” another element, there are no intervening elements present. It will be understood that when an element is referred to as being “connected” or “coupled” to another element, it can be directly connected or coupled to the other element or intervening elements may be present. In contrast, when an element is referred to as being “directly connected or coupled” to another element, there are no intervening elements present. Furthermore, “connected” or “coupled” as used herein may include wirelessly connected or coupled. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first layer could be termed a second layer, and, similarly, a second layer could be termed a first layer without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” “left” or right” may be used herein to describe one element's relationship to other elements as illustrated in the Figures. It will be understood that relative terms are intended to encompass different orientations of the device in addition to the orientation depicted in the Figures. For example, if the device in one of the figures were turned over, elements described as being on the “lower” side of other elements would then be oriented on “upper” sides of the other elements. The exemplary term “lower”, can therefore, encompass both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Optionally the preferred embodiments may involve Global Positioning Satellite system usage.

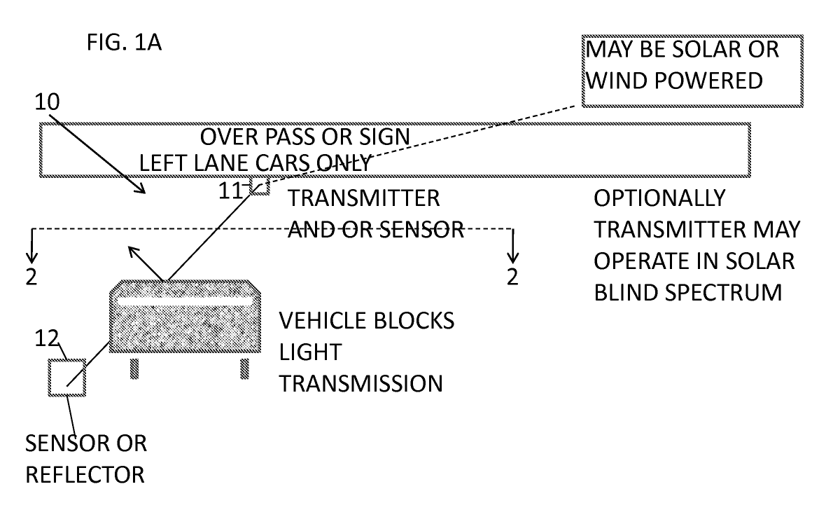

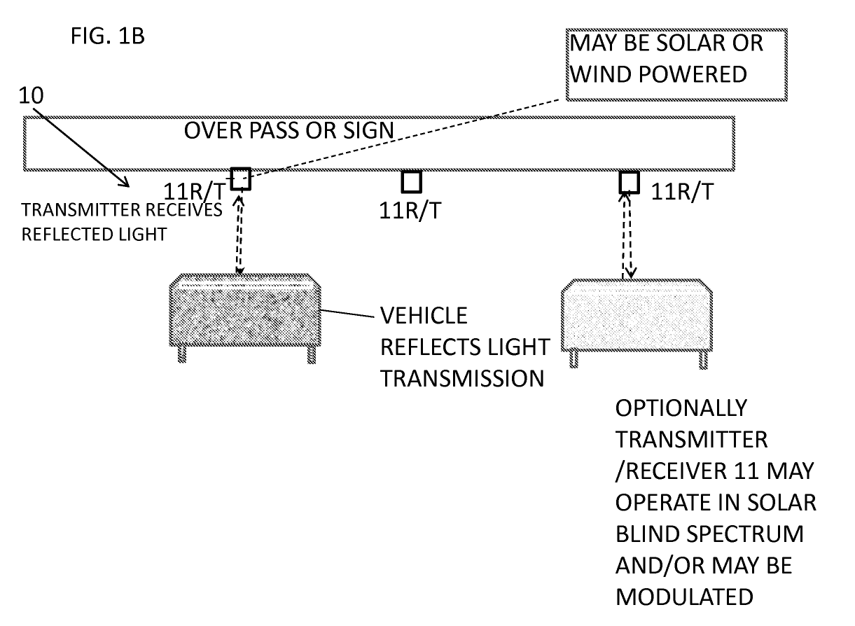

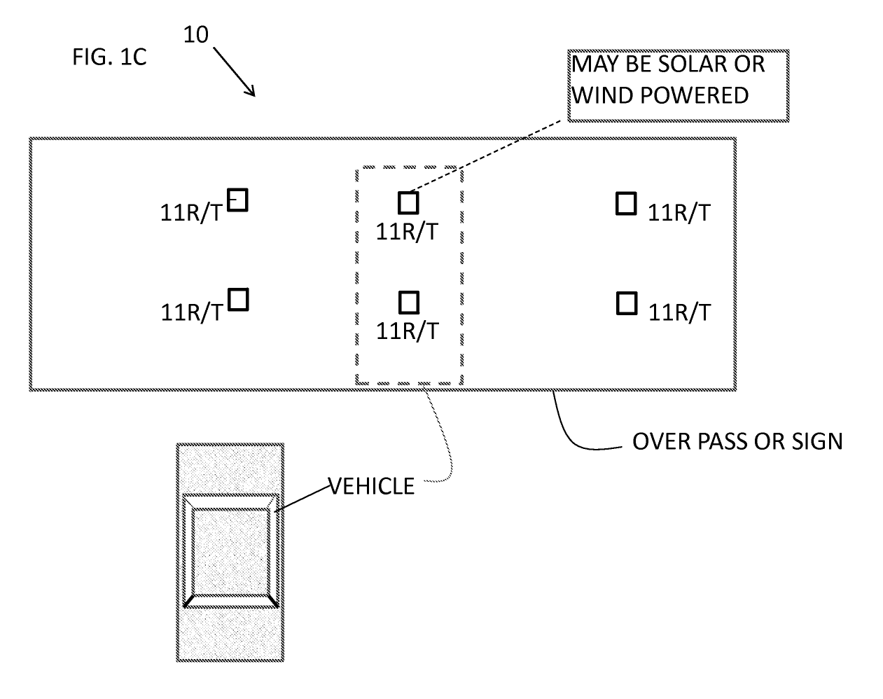

FIG. 1A is a schematic illustration of a preferred embodiment traffic monitoring system comprising an overhead transmitter and ground based sensor or reflector. The transmitter 11 may comprise an electromagnetic wave transmitter which transmits waves which are blocked or intercepted by a vehicle as the vehicle passes nearby as shown in FIG. 1A. The transmitter 11 may comprise a laser which operates in the solar blind region to avoid interference or confusion with sunlight. The transmitted waves emitted from transmitter 11 may also be modulated so as to be distinguishable from other sources of radiated electromagnetic waves. The reception (or lack of reception) by sensor or reflector 12 will indicate the passage of a vehicle. The traffic lane may be designated cars only so that the measured vehicles are limited to cars. Given that cars do not vary greatly in length, a somewhat accurate speed assessment may be obtained. The sensed data may to averaged so that an approximate portrayal of traffic speed is obtained. The sensor 12 may be a photodetector or may reflect light back to the transmitter 11. The sensors may be mounted at ground level along the highway. Alternately, the element 12 may comprise a reflector mounted in the pavement surface. This would facilitate pavement resurfacing as new reflectors could be repositioned after pavement resurfacing. The transmitters may be positioned in a variety of ways including mounted to overpasses on the interstate, light poles or signs. Alternatively, the transmitters 11 could be mounted at ground level and the sensors 12 could be mounted to the signs, over passes or light poles. In order to obtain power for the electromagnetic transmitters 11, solar or wind power could be used. A solar panel could be positioned nearby or a wind turbine could be used to supply electric power. This makes the devices 10 independent of the need to connect them to the local grid and facilitates location and relocation of the devices to adapt to situational requirements. For example, if a highway is restructured, the devices 10 could be dismounted and remounted in a new location without the necessity of disconnection and reconnection to the local electrical grid. This is especially desirable when there is no electrical wiring or 4 source nearby.

Inasmuch as it would be undesirable to detect sunlight, the detector could be limited to light in the solar blind spectrum or could be modulated to distinguish the detected light from surrounding sources of electromagnetic radiation.

FIG. 1B is a schematic illustration of an alternate preferred embodiment traffic monitoring system comprising a combined overhead transmitter and sensor 11R/T. The electromagnetic radiation emitted from the transmitter receiver 11R/T is reflected by the surface of the vehicle into the transmitter receiver 11R/T. The radiation emitted from transmitter receiver 11R/T may be such that is not reflected by the pavement beneath the car. Alternately, a metal detector may be used, or radar which detects the presence of metallic elements. As shown in FIG. 1B, for multiple lanes, each lane may have a transmitter receiver 11R/T. Optionally, the vehicle speeds for each lane may be averaged and the traffic flow may be totaled. A combination of the devices 11 may be utilized inasmuch as the middle lane may rely on a reflective device as shown in FIG. 1B while the inner and outer lanes may utilize detectors as shown in FIG. 1A. Once again the transmission of electromagnetic radiation may be in the solar blind region to distinguish it from solar radiation. The electric power for system operation may come from a solar or wind power source or may be battery powered or connected to the electrical grid.

FIG. 1C is a schematic illustration from an overhead view point of a preferred embodiment traffic monitoring system comprising an array of overhead receiver/transmitters 11. The array may be the transmitters of FIG. 1A or FIG. 1B as each is compatible for operation with the arrangement depicted in FIG. 1C. As seen in FIG. 1C as vehicle shown by dotted lines in beneath the array in the middle lane while a vehicle is approaching in the left lane. The array may be mounted to an overpass, bridge, walkway, sign or light pole. Alternately, a structure may be used exclusively for the positioning of the transmitters 11R/T through a structure constructed similar to an overhead sign structure. In the case of radar, a radar transmitter and/or receiver may be positioned at the side of the roadway.

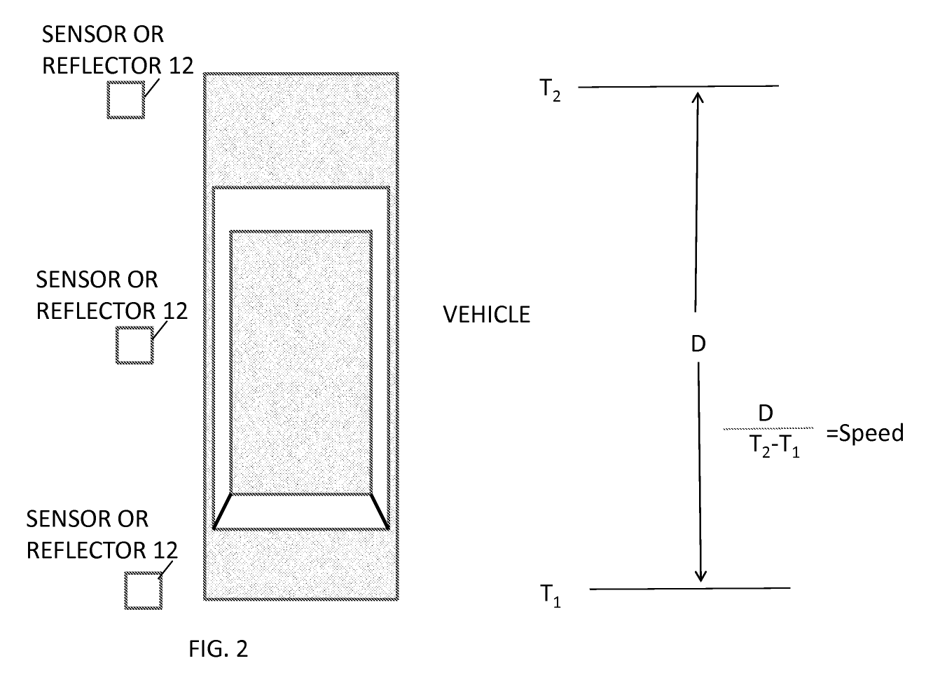

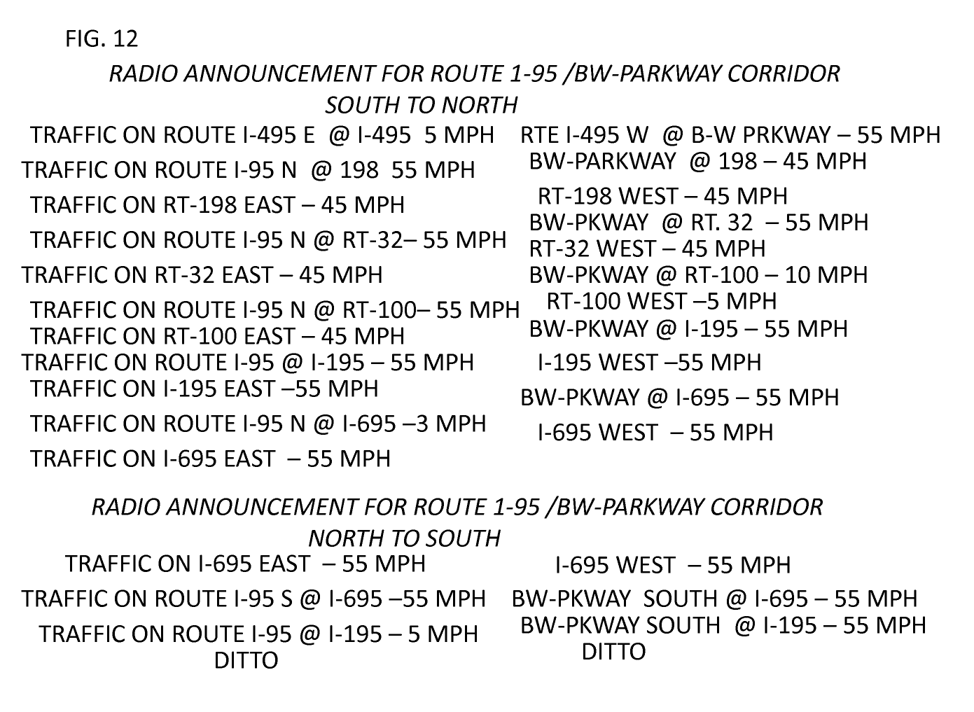

FIG. 2 is a schematic illustration of the preferred embodiment of FIG. 1A taken along the lines 2-2 of FIG. 1. Although three sensors/reflectors 12 are shown, two, four or more may work. As the front of the vehicle passes the first sensor 12 (lowermost in FIG. 12) the time is recorded (T₁). The middle sensor 12 may be used to show continuity, that is when the topmost sensor detects the presence of the vehicle, detection by the middle sensor assures that there is a single car involved and not detection of two vehicles with a space therebetween. As the front of the vehicle passes the uppermost sensor (as depicted in FIG. 2) the time is recorded (T₂). Knowing the distance between the sensors (upper and lower as depicted in FIG. 2, the distance traveled between the two instances in time (T₂−T₁) can be used to determine the speed. One the determination is recorded, it can be averaged with other readings to determine an average for the traffic. The recording can also be used to record the traffic flow, that is, each time one vehicle passes the electromagnetic radiation is blocked by the vehicle followed by a time interval in which the electromagnetic radiation is not blocked. Each such sequence (blocked followed by unblocked) represents the passage of a vehicle. Upon detecting vehicles over a period of time, such as one minute, the traffic flow per minute can be determined. Moreover, the traffic flow number is sensitive to recent stoppages or obstructions of traffic. For example if in the previous mile, two of the three lanes were obstructed, the speed of the traffic at this point would logically resume whereas the volume of traffic may be light due to the previous obstruction inhibiting the flow of traffic. If the traffic flow at a previous monitoring point was 60 cars per minute and the traffic flow is only five cars per minute as the present juncture, one might suspect an obstruction of traffic in the intermediate section of the roadway which would be cause for avoiding travel on that section.

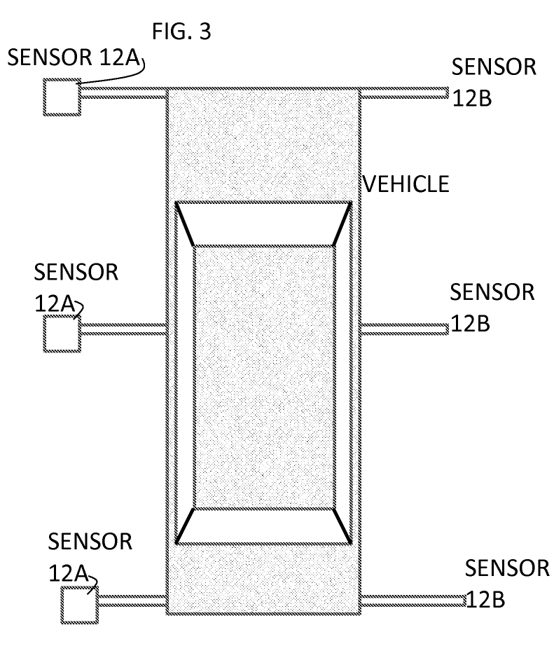

FIG. 3 is a schematic illustration of an alternate preferred embodiment comprising ground based sensors 12A with roll-over detector strips 12B. Although three strips are shown, two may be used; or an unlimited plurality such as, for example 4. The strips 12B may be compressible hose which record a signal as the vehicle tires compress the hose or tubing. Alternately the sections 12B may be metallic contact strips which complete an electrical circuit as a car's tires pass over the metal contacts. The detection of vehicle is substantially the same as the front of the vehicle passes the lowermost strip the time is recorded (T₁). The middle sensor 12 may be used to show continuity, that is when the topmost sensor detects the presence of the vehicle, detection by the middle sensor assures that there is a single car involved and not detection of two vehicles with a space therebetween. As the front tire of the vehicle passes the uppermost sensor (as depicted in FIG. 3) the time is recorded (T₂). Knowing the distance between the sensors (upper and lower as depicted in FIG. 2, the distance traveled between the two instances in time (T₂−T₁) can be used to determine the speed. Once the determination is recorded, it can be averaged with other readings to determine an average for the traffic. The recording can also be used to record the traffic flow, that is, each time a vehicle passes over the detector strip, a recording is made.

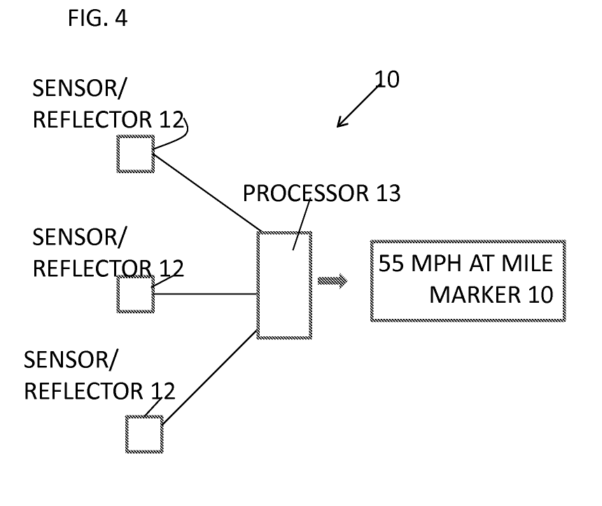

FIG. 4 is a schematic illustration of a preferred embodiment electrical circuitry diagram wherein the sensors 12 are electrically connected to a processor 13. The electric connection may be by wire or radio (wireless) type connection. The processor 13 is used to record signals indicating presence or passage of a vehicle and the speed may or may not be recorded at this point. If the speed is calculated, the processor in conjunction with a transmitter may emit a radio signal indicative of vehicular speed, such as “55 MPH” at the location of the traffic monitoring device 10.

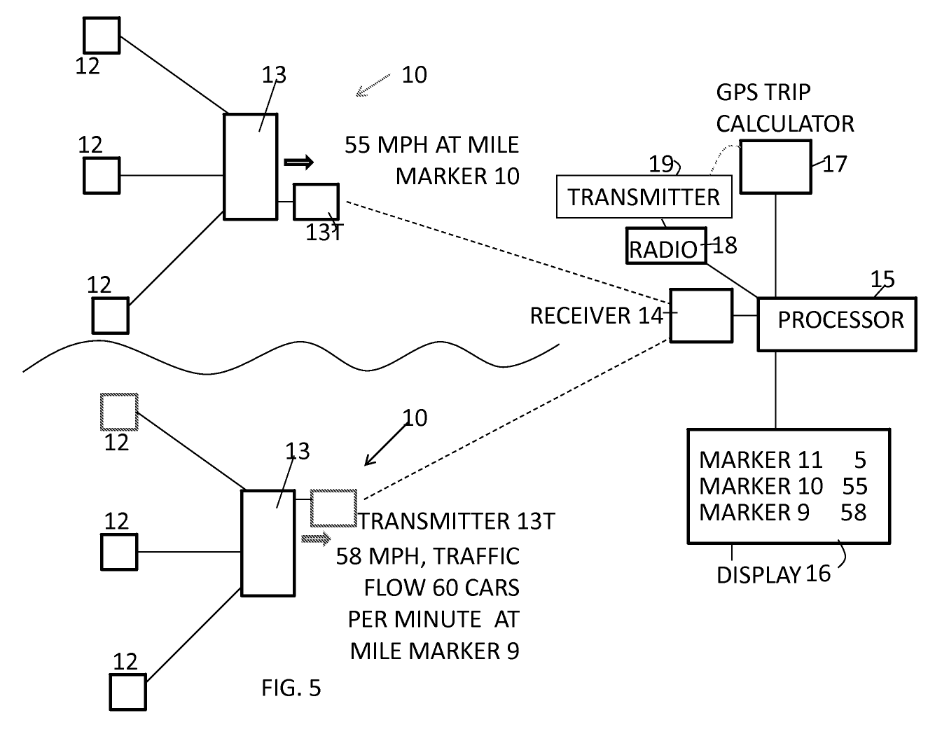

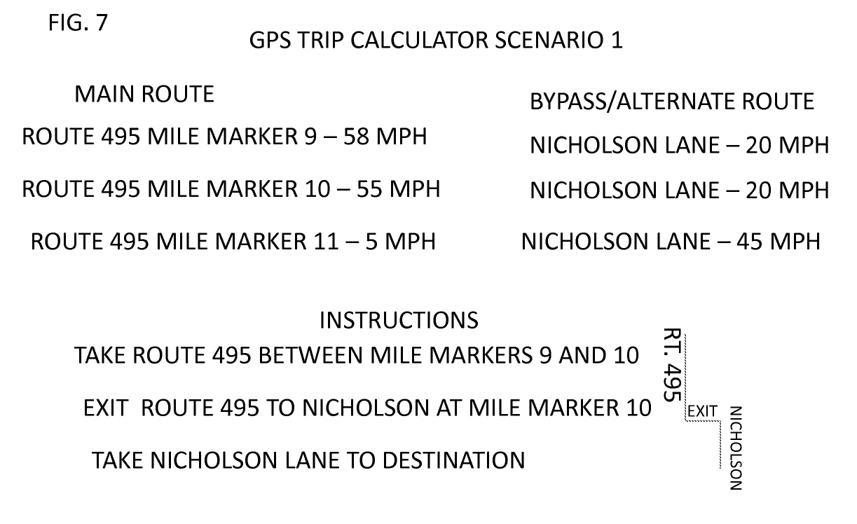

FIG. 5 is a schematic illustration a plurality of traffic monitoring devices 10 operatively connected to a receiver 14 and processor 15 for display 16, GPS trip calculation 17 and/or radio 18. Each traffic monitoring system 10 comprises one or more transmitters 11, and sensors or reflectors 12. Note that if only one transmitter is used signals can be transmitted to sensors/reflectors 12 from one central location or a plurality of spaced apart transmitters 11 may be utilized, such as for example, one of which is depicted in FIG. 1. The detected signal may be combined at a processor, combiner, or controller 13. The processor, combiner or controller 13 may have associated therewith a transmitter 13T which transmits a radio signal. The radio signal may be a time signal such as “traffic is flowing at 55 MPH at location X.” This signal may be directly received by a vehicle radio receiving the transmitted signal. Or the signal may be such that a GPS device, such as a Magellan® or Garmin®, may detect the signal for further processing as shown in FIG. 7, 8, or 11, for example. In the alternative, the transmitter 13T may send a signal to a remote receiver 14 operatively connected to a processor 15 which may compute the average speed and/or traffic flow at the location of the traffic monitoring device(s) 10. The signals may be combined for display on a highway sign 16 which may be positioned at the entrance of a limited access highway or along the limited access highway so that a driver may, for example, exit at mile marker 10 if the traffic at mile marker 11 is only 5 MPH. The processor or controller 15 may be operatively connected to a GPS trip calculator 17 (such as a Magellan® or Garmin® in a motorist's car) which can in turn process the signal to reroute traffic depending on traffic flow and/or speed. In addition, the processor 15 may be operatively connected to a radio transmitter combination 18, 19 which transmits locally over a frequency for reception by a motorist on the radio of the motorist's car. In the alternative, the receiver may be directly connected to a radio transmitter 19 so as to effectively broadcast the traffic speed and/or the traffic flow volume over the radio network for reception by a motorist's radio. The transmission by the transmitter may be used by the GPS device so that calculations will be made on the motorist's GPS device (e.g., a Magellan® or Garmin®) located in the motorist's car. In conjunction with the system depicted in FIG. 5, the sensors could be the rollover sensors of FIG. 3, or any other sensor disclosed herein.

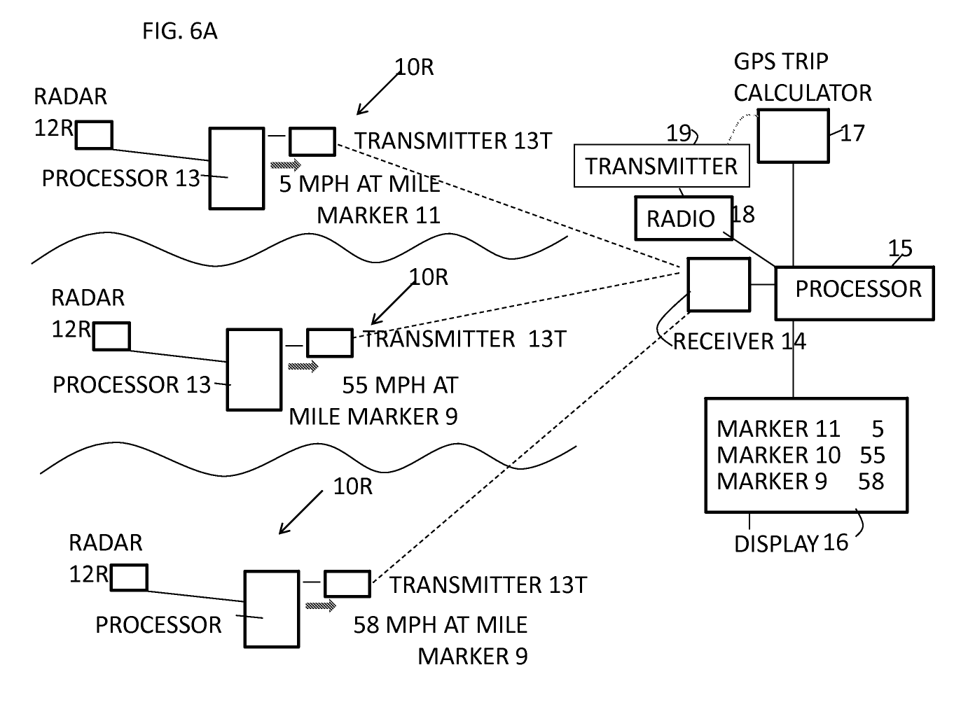

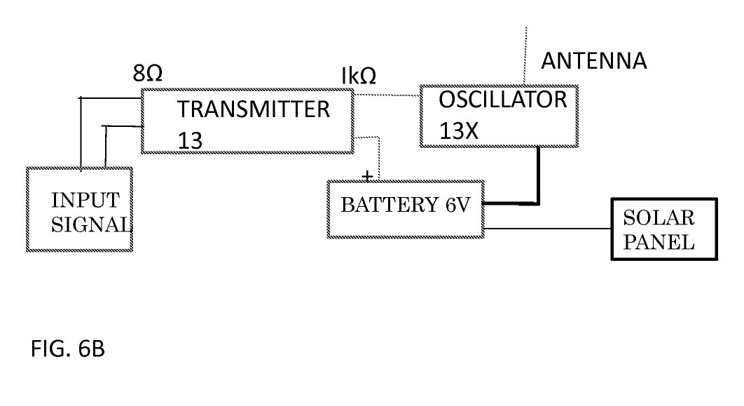

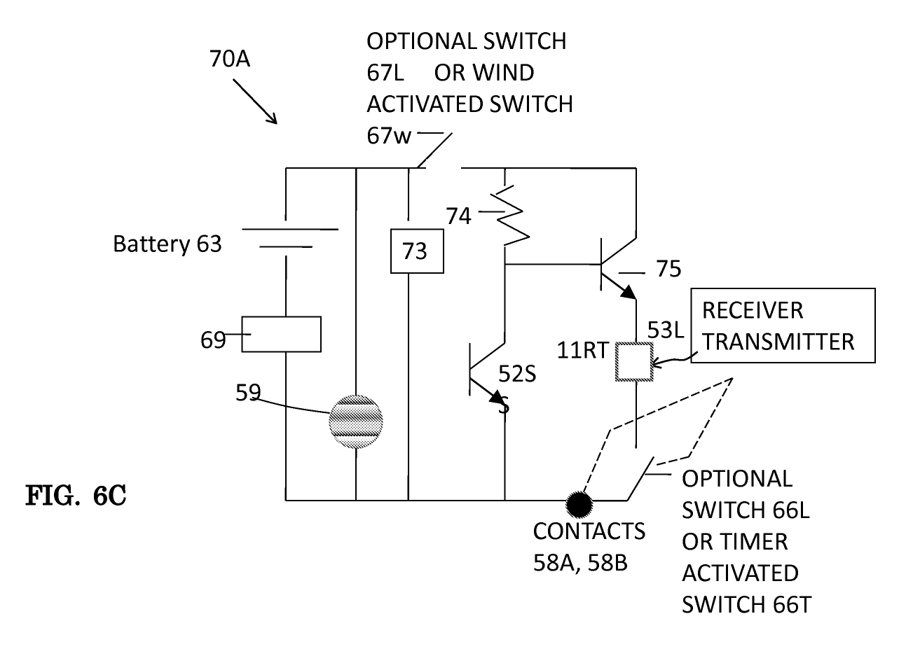

FIG. 6 is a schematic illustration of a plurality of traffic monitoring devices 10 using radar transmitters/receivers operatively connected to a receiver 14 and processor 15 for display 16, GPS trip calculation 17 and/or radio 18. Radar elements 12R detect vehicles as they pass by. Vehicular speed is relayed or transmitted by transmitters 13T, which transmits a radio signal. The radio signal may be a time signal such as “traffic is flowing at 55 MPH at location X.” This signal may be directly received by a vehicle radio receiving the transmitted signal. Or the signal may be such that a GPS device, such as a Magellan® or Garmin®, may detect the signal for further processing as shown in FIG. 7, 8, or 11, for example. In the alternative, the transmitter 13T may send a signal to a remote or nearby receiver 14 operatively connected to a processor 15 which may compute the average speed and/or traffic flow at the location of the traffic monitoring device(s) 10R. The signals may be combined for display on a highway sign 16 which may be positioned at the entrance of a limited access highway or along the limited access highway so that a driver may, for example, exit at mile marker 10 if the traffic at mile marker 11 is only 5 MPH. The processor or controller 15 may be operatively connected to a GPS trip calculator 17 (such as a Magellan® or Garmin® in a motorist's car) which can in turn process the signal to reroute traffic depending on traffic flow and/or speed. In addition, the processor 15 may be operatively connected to a radio transmitter combination 18, 19 which transmits locally over a frequency for reception by a motorist on the radio of the motorist's car. In the alternative, the receiver may be directly connected to a radio transmitter 19 so as to effectively broadcast the traffic speed and/or the traffic flow volume over the radio network for reception by a motorist's radio. The transmission by the transmitter may be used by the GPS device so that calculations will be made on the motorist's GPS device (e.g., a Magellan® or Garmin®) located in the motorist's car. In conjunction with the system depicted in FIG. 6, the sensors could be the rollover sensors of FIG. 3, or any other sensor disclosed herein.

FIG. 7 is an illustration of an example of a GPS trip calculation scenario. As shown in the table below.

GPS Trip Calculator Scenario 1

MAIN ROUTE BYPASS/ALTERNATE ROUTE

Rte. 495 Mile Marker 9-58 MPH Nicholson Lane at corresponding stretch 20 MPH

Rte. 495 Mile Marker 10 55 MPH Nicholson Lane at corresponding stretch 20 MPH

Rte. 495 Mile Marker 11 5 MPH Nicholson Lane at corresponding stretch 45 MPH

The resulting traffic instructions may be as follows:
TAKE ROUTE 495 BETWEEN MILE MARKERS 9 AND 10
   EXIT ROUTE 495 TO NICHOLSON AT MILE MARKER 10
      TAKE NICHOLSON LANE TO DESTINATION

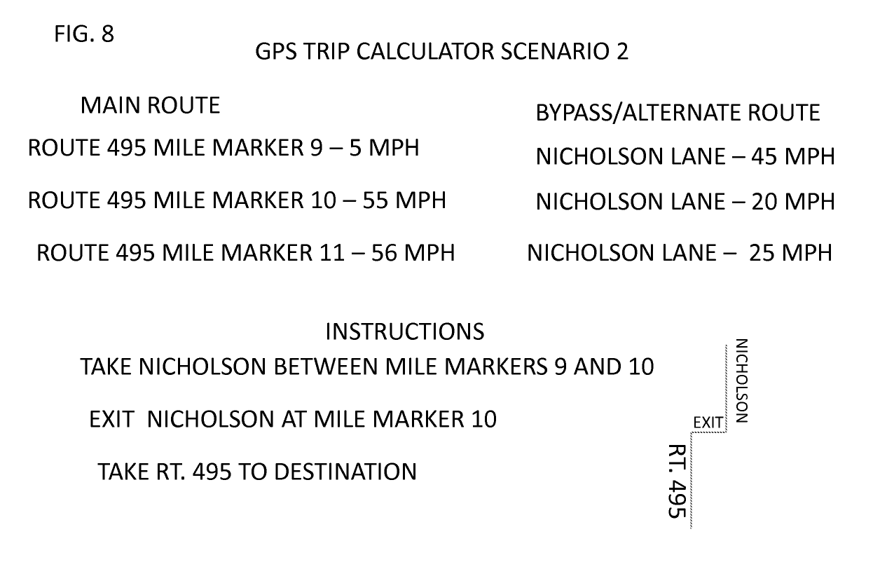

FIG. 8 is another illustration of an example of a GPS trip calculation; scenario 2, as shown in the following table:

GPS Trip Calculator Scenario 3

MAIN ROUTE BYPASS/ALTERNATE ROUTE

Rte. 495 Mile Marker 9-5 MPH Nicholson Lane at corresponding stretch 45 MPH

Rte. 495 Mile Marker 10 55 MPH Nicholson Lane at corresponding stretch 20 MPH

Rte. 495 Mile Marker 11 56 MPH Nicholson Lane at corresponding stretch 25 MPH

The resulting traffic instructions may be as follows:

Take Nicholson Lane between Mile Markers 9 and 10, exit Nicholson Lane at Mile Marker 10 and take Route 495 to destination. The above scenarios are fictions and are merely intended to describe or depict examples of scenarios which may be adaptable to multiple road conditions and roads throughout the world. The idea being that as traffic flow varies, traffic may be expeditiously rerouted to save energy costs and motorists time.

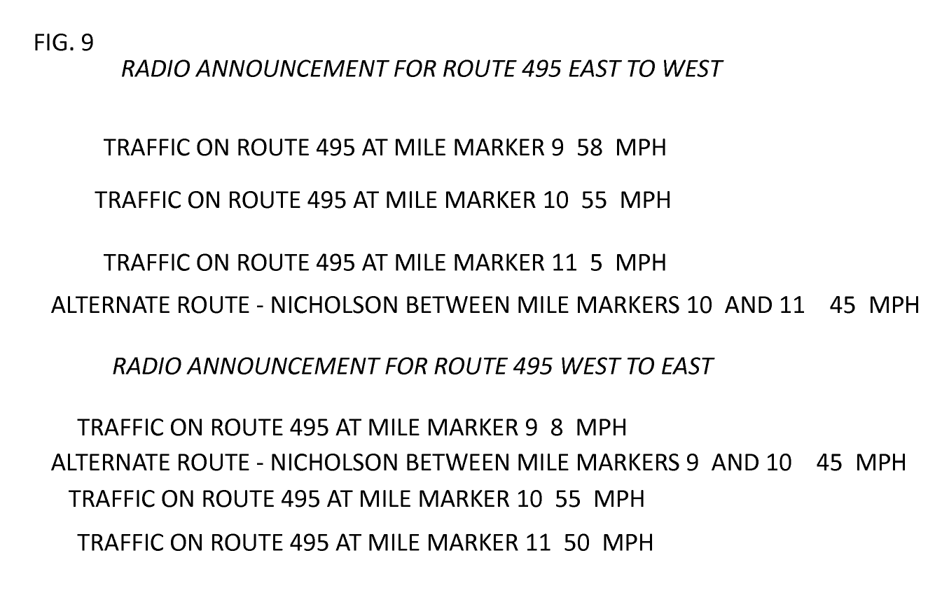

FIG. 9 is a illustration diagramming and/or outlining an example of a radio announcement for a scenario involving traffic on a arbitrarily selected route I-495, as shown in the following table.

Radio Announcement for Route 495 East to West

Traffic on Rte. 495 Mile Marker 9-58 MPH; traffic flow 105 cars per minute

Radio Announcement for Route 495 East to West

Traffic on Rte. 495 Mile Marker 9-58 MPH; traffic flow 105 cars per minute

Traffic on Rte. 495 Mile Marker 10 55 MPH; traffic flow 100 cars per minute

Traffic on Rte. 495 Mile Marker 11 5 MPH; traffic flow 5 cars per minute

An automatic computer generated message and/or resulting traffic instructions may be as follows: For traffic east to west on Rte 495, exit at or near Mile Marker 10 to avoid traffic slow down at Mile Marker 11.

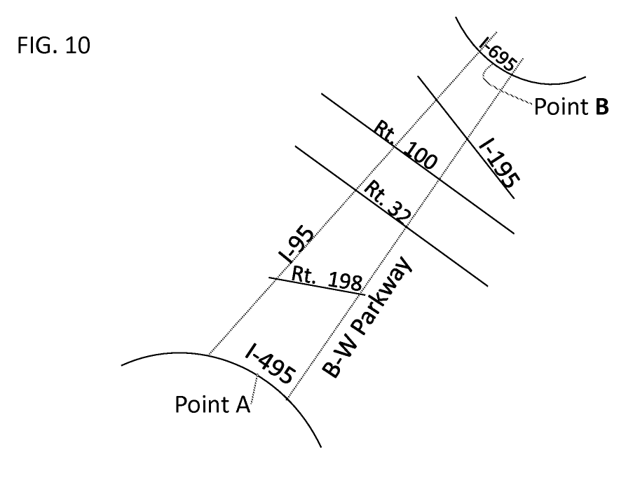

FIG. 10 is an illustration depicting a map of an example of a corridor in which alternate routes are available, including two limited access highways. As an example, the map approximates an area between the cities of Baltimore and Washington and in particular Interstate 1-95 and the Baltimore Washington Parkway. Since I-95 has more lanes, it is the preferred route. Both routes are limited access routes where traffic may become ensnarled between exits. Signs posted along the highways could alert the motorists to the then current conditions in the roadway ahead to allow consideration of an alternate route. Such an alternate route choice for the thousands of cars using this corridor every day would result in more efficient energy usage, savings of energy costs and motorists time. The scenario depicted by the map in FIG. 10 envisions a trip from point A near the Route 495 Beltway encircling Washington D.C. to a point B near the Route 695 Beltway encircling Baltimore Md. The points and routes are merely exemplary to show the benefits of using a preferred embodiment of the invention.

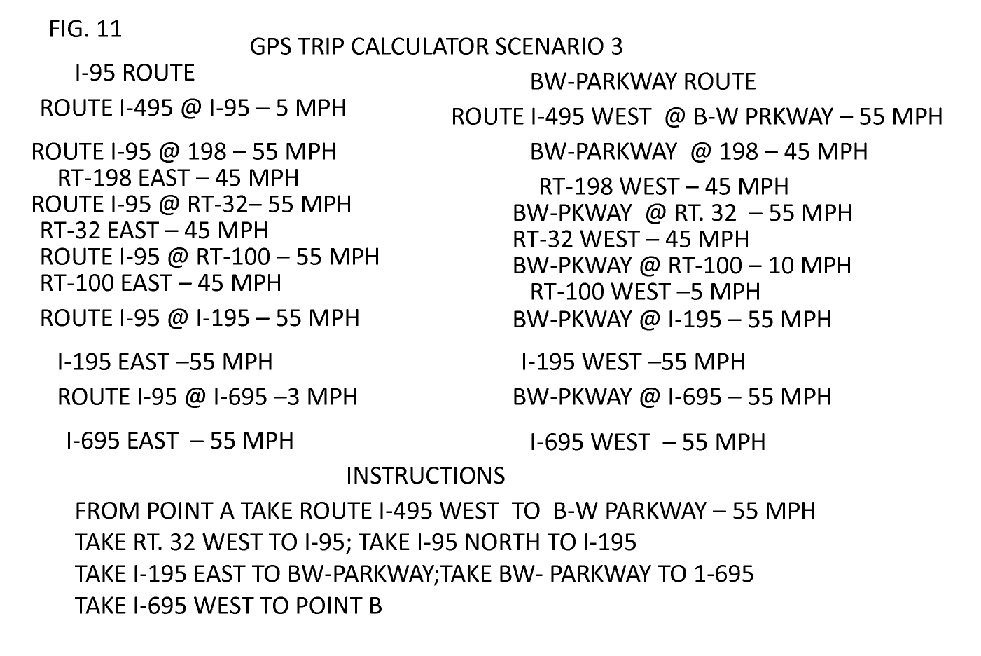

FIG. 11 is an illustration of a GPS trip calculation scenario for the area depicted in the map illustration of FIG. 10; scenario 5, as shown in the following table:

GPS TRIP CALCULATOR SCENARIO 3

| MAIN ROUTE | BYPASS/ALTERNATE ROUTE |
|---|---|
| Rte. 495 East @ I-95 - 5 MPH | Rte I-495 West @ B-W Parkway - |
| | 55 MPH |
| Rte. I-95 @ Route 198 55 MPH | B-W Parkway @ 198 45 MPH |
| Route 198 east - 45 MPH | Route 198 west - 45 MPH |
| Rte. I-95 @ Route 100 55 MPH | B-W Parkway @ Rte. 100 10 MPH |
| Route 100 east - 45 MPH | Route 100 west - 5 MPH |
| Rte. I-95 @ Route I-195 55 MPH | B-W Parkway @ Rte. I-195 55 MPH |
| Route I-195 east - 55 MPH | Route I-195 west - 55 MPH |
| Rte. I-95 @ Route I-695 3 MPH | B-W Parkway @ Rte. I-695 55 MPH |

Instructions:

From point A take Route I-495 West to B-W Parkway (55 MPH). Take Route 32 West to I-95, Take I-95 North to I-195, Take I-195 East to B-W Parkway, Take BW Parkway to I-695 West to point B.

Using the above, the near stoppages of traffic on I-495 East and on I-95 at I-695 are avoided; avoiding costly delayed and increased energy costs. The above scenarios are fictions and are merely intended to describe or depict examples of scenarios which may be adaptable to multiple road conditions and roads throughout the world. The idea being that as traffic flow varies, traffic may be expeditiously rerouted to save energy costs and motorists time.

FIG. 12 is an illustration of a diagram of a radio announcement sequence for the area depicted in the map illustration of FIG. 10, as shown in the following table.

RADIO ANNOUNCEMENT FOR ROUTE 1-95/BW-PARKWAY
CORRIDOR SOUTH TO NORTH

| | |
|---|---|
| TRAFFIC ON ROUTE I-495 E | RTE I-495 W @ B-W PRKWAY - |
| @ I-495 5 MPH | 55 MPH |
| TRAFFIC ON ROUTE I-95 N | BW-PARKWAY @ 198 - 45 MPH |
| @ 198 55 MPH | |
| TRAFFIC ON RT-198 EAST - | RT-198 WEST - 45 MPH |
| 45 MPH | |
| TRAFFIC ON ROUTE I-95 N | BW-PKWAY @ RT. 32 - 55 MPH |
| @ RT-32 - 55 MPH | |
| TRAFFIC ON RT-32 EAST - | RT-32 WEST - 45 MPH |
| 45 MPH | |
| TRAFFIC ON ROUTE I-95 N | BW-PKWAY @ RT-100 - 10 MPH |
| @ RT-100 - 55 MPH | |
| TRAFFIC ON RT-100 EAST - | RT-100 WEST - 5 MPH |
| 45 MPH | |
| TRAFFIC ON ROUTE I-95 | BW-PKWAY @ I-195 - 55 MPH |
| @ I-195 - 55 MPH | |
| TRAFFIC ON I-195 EAST - | I-195 WEST - 55 MPH |
| 55 MPH | |
| TRAFFIC ON ROUTE I-95 N | BW-PKWAY @ I-695 - 55 MPH |
| @ I-695 - 3 MPH | |
| TRAFFIC ON I-695 EAST - | I-695 WEST - 55 MPH |
| 55 MPH | |

RADIO ANNOUNCEMENT FOR ROUTE 1-95/BW-PARKWAY
CORRIDOR NORTH TO SOUTH

| | |
|---|---|
| TRAFFIC ON I-695 EAST - | I-695 WEST - 55 MPH |
| 55 MPH | |
| TRAFFIC ON ROUTE I-95 S | BW-PKWAY SOUTH @ I-695 - |
| @ I-695 - 55 MPH | 55 MPH |
| TRAFFIC ON ROUTE I-95 | BW-PKWAY SOUTH @ I-195 - |
| @ I-195 - 5 MPH | 55 MPH |
| TRAFFIC ON ROUTE I-95 | BW-PKWAY SOUTH @ I-195 - |
| @ I-195 - 5 MPH | 55 MPH |

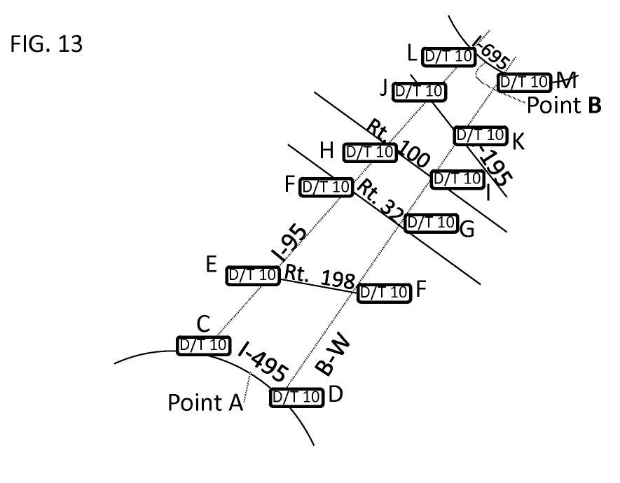

FIG. 13 is an illustration of the mapped area of FIG. 10 showing possible placement of traffic monitoring devices D/T 10, which may be the systems of FIG. 1, FIG. 2, FIG. 3, FIG. 4, FIG. 5, and/or FIG. 6.

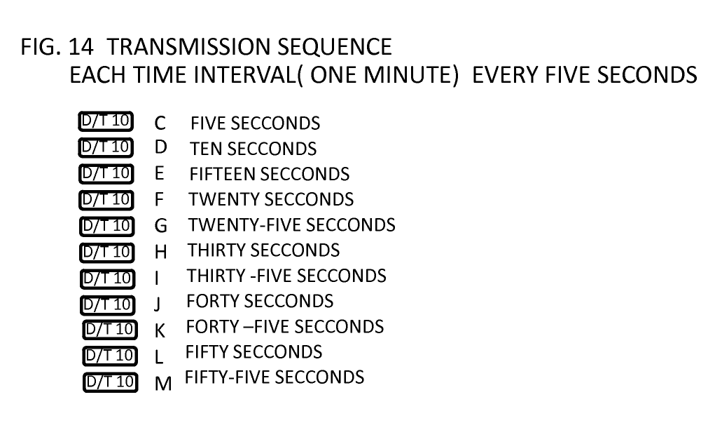

FIG. 14 is an illustration depicting the sequencing of transmissions from the devices D/T 10 of FIG. 13. In the example depicted, each detector/transmitter 10, labeled C through M would broadcast in a given time slot spaced five seconds apart. Accordingly, in one methodology a motorist would hear the individual broadcast as a continuous transmission on the motorist' radio. As described early, each individual transmission may be made from the location of the detector transmitter unit 10. Alternately, both directions in the roadway may be broadcasted as shown in the lower portion of the FIG. 13.

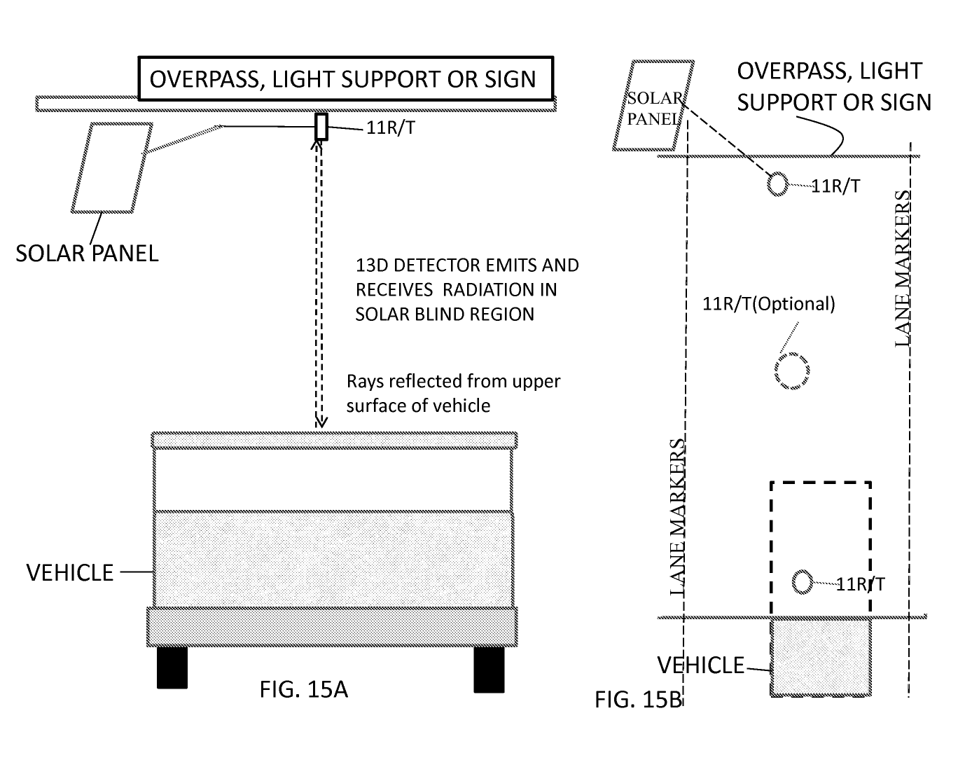

FIGS. 15A and 15B (overhead view) depict an additional preferred embodiment in which the detectors 11R/T may comprise a plurality of transmitter/receivers which transmit and detect light in the solar blind region, so that sun light will not interfere with the detection of vehicles. As seen in FIG. 15A the transmitter/receiver 11R/T emits light in the solar blind region which is reflected off of a passing vehicle. Based upon the distance between the transmitter/receivers 11R/T, one may calculate the speed of the vehicle (distance/time). It is noted that the detectors 11R/T must be adjusted to discount reflections from the pavement or roadway surface. This may be accomplished by modulating and timing the pulses so the pulses so that only pulses which are reflected at a distance substantially less than those reflected from the roadway surface are used in the computation. As show in FIGS. 15A and 15B, the transmitters/receivers 11R/T may be powered by a solar panel, or alternatively by wind power. Transmitter receivers may be connected into and used in conjunction with the circuitry shown in FIGS. 5, 6A, 6B and/or 16. Likewise, the circuitry of FIGS. 5, 6A and 6B may be solar or wind powered.

Shown in FIG. 15B is an overhead view of the embodiment of FIG. 15A wherein the transmitters/receivers (detector) 11R/T are arranged under a sign, overpass or lighting support a set distance apart. The middle transmitters/receivers (detector) is optional. However, although three are shown, two may suffice or four, five or six may be used to increase the detection capability and reliability.

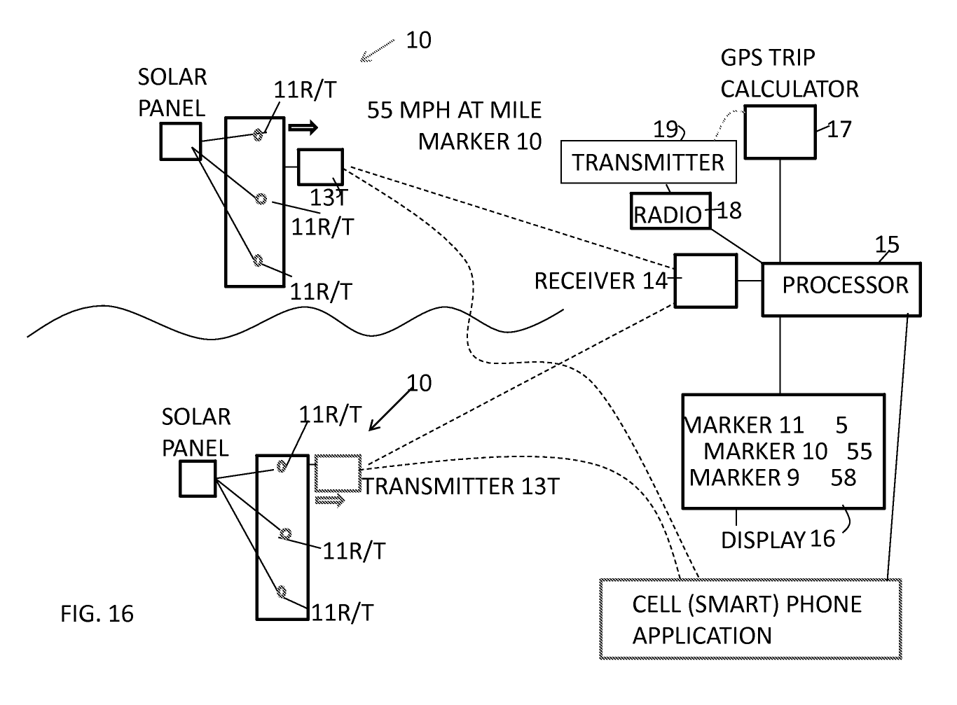

FIG. 16 is a further description of a preferred embodiment wherein the concepts may be used in conjunction with the circuitry shown in FIGS. 5, 6A, and/or 6B. A cell phone application may be used to display the traffic information on a so-called smart phone. The smart phone may derive the information from a cellphone transmitters in which transmitter 13T is capable of generating a cell phone signal or through processor 15 which may be interconnected to a cellphone network. As modified the cell phone could have the capability of displaying traffic speeds in a manner similar to Display 16. Moreover, transmitters 13T may operate at a given frequency range, for example 630 AM and be localized so that only radios in the vicinity can receive the signal. The signals could be transmitted in a sequencing manner shown in FIG. 14.

An application, such as a smart phone application, could receive and display these signals as shown, for example in Display 16. Similarly, the signals could be transmitted to a GPS receiver, which may then plan routes dependent upon the speed or volume of vehicular traffic. The signals could be transmitted in a manner shown in FIG. 14.

Optionally, the monitors may be traffic cameras from which data is gathered by a person monitoring the display screen and relayed by voice over a predetermined radio frequency. Or the radio station may be composed of members of the public using the highway to enlighten others as to traffic tie-ups, accidents, and jams.

An optional configuration would make the processor 15 interconnect with the cellphone or cell phone application. For example, the processor 15 could send signals via cell phone frequency wavelengths for reception by a cellphone user.

In another embodiment, cars using GPS systems are interacting with the satellites overhead in the sky. Using the points of interaction and the time of travel between points, the speed of travel can be determined. This information could be relayed via the satellite to a ground station which would determine vehicular speeds based upon average speed data collected on various highways.

In accordance with an alternate embodiment, GPS location data would be used by a company, group of companies, groups of motorists, or local or national government. The location data would be provided by GPS position sensors within motor vehicles and relay to sources which use the GPS position data to determined average speeds along a roadway.

### Solar-Wind Power Source

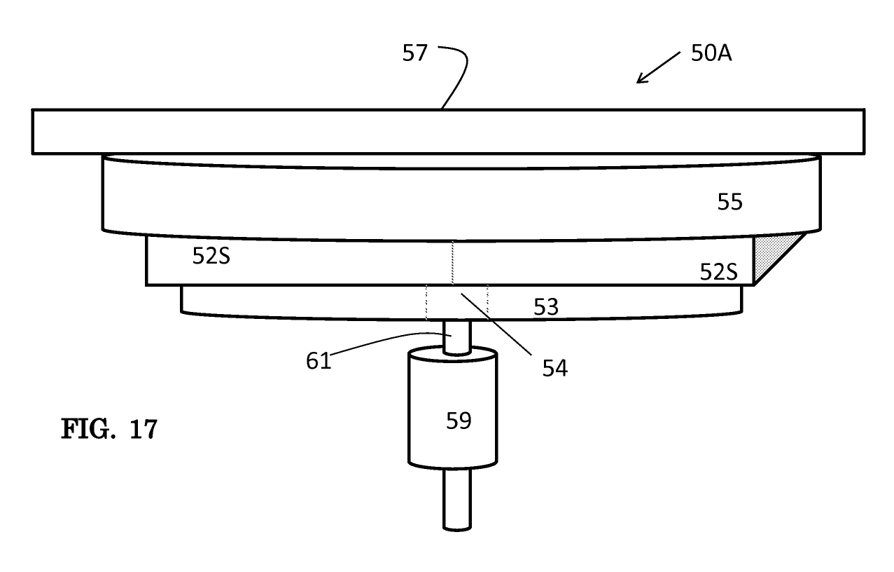

FIG. 17 is a side view of a preferred embodiment of the present invention. The assembly shown in FIG. 17 is a preferred embodiment assembly 50A comprising solar panel support surface 52S, support 53, central portion 54, cover 55, wind direction detector 57, and motor/generator 59. It can be readily appreciated by those of ordinary skill in the art that the solar support surface 52 may comprise one or a plurality of panels 52S and may take a variety of forms, such as circles, squares, rectangles or arcuate sections. The solar panels 52 may range in dimensions from 1 inch by one inch to two square feet depending on the application, power requirements, and resources available. The support 53 is shown as a “disk” but can be any configuration or form and may support a variety of photo emission devices including emission devices which emit light in the solar blind region of the spectrum. Support 53 may support LED 3L; which may be a plurality of up to 50 depending on the intensity desired. However, in the traffic monitoring application, it is intended that the solar and wind power generated by the assembly of FIG. 17 be used to power, inter alia, transmitter/receivers 11-12, 11R/T, and 12R. Moreover, the selection of transmitter/receivers 11-12, 11R/T, and 12R is exemplary and any type of light or electromagnetic wave may be used without departing from the scope of the invention. The function of the solar support 52 and support 53 may be combined and a single support may perform both functions. Additionally, the solar support 52 and support 53 as well as solar diodes 52S and electromagnetic wave emitters may be one integral unit.

Assembly 50 further comprises vanes 56 mounted on the support 53. The vanes may be plastic or aluminum or any material which provides a light weight, durable, rigid construction. The vanes cause the support 53 to turn in response to the force of the wind. Wind screen 55 is substantially semicircular in configuration and shields one side of the support 53 while the other side is subjected to the wind. Wind screen 55 is rotatably mounted and is controlled by central vane 57 which responds to wind direction. In addition, support 53 is operatively attached to central portion 54 so as to rotate as motor/generator 59 turns.

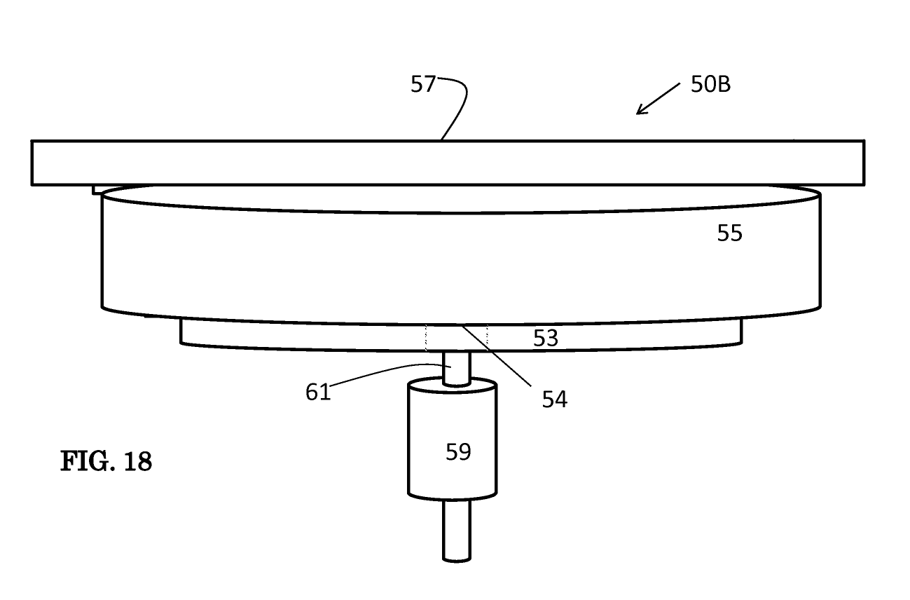

As shown in FIG. 18, the wind screen covers half of the vanes 56 so that the force applied by the wind to the vanes cases them to turn in a single direction. Other configurations which achieve this result are contemplated within the scope of the invention. The wind screen is substantially clear so as to allow the sun rays to penetrate to the solar panels 52.

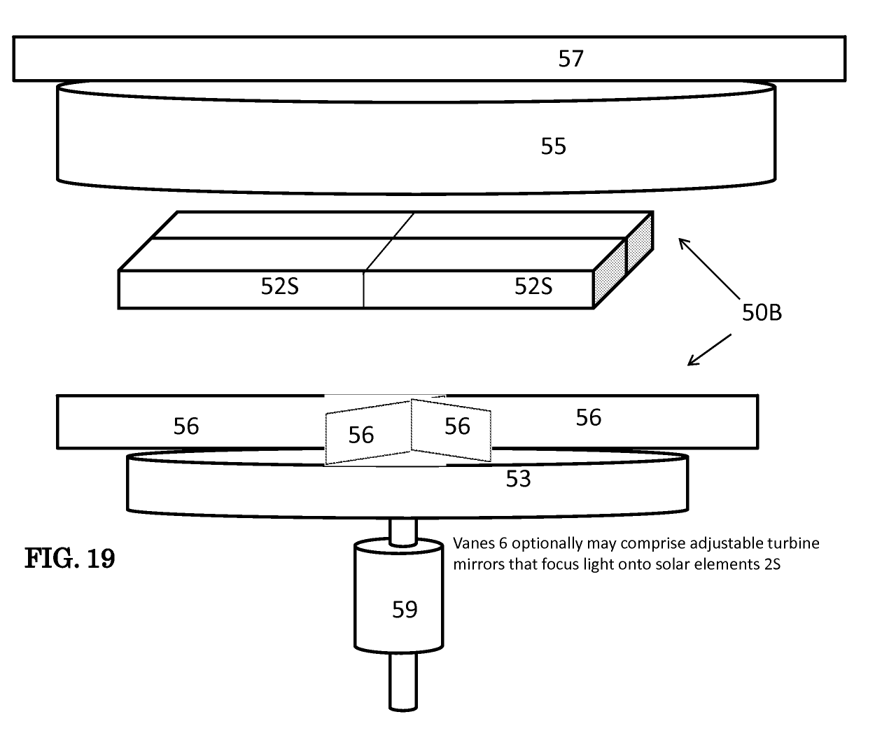

Shown in FIG. 19 is a preferred embodiment in which the vanes 56 are positioned between the solar panels 52 and support 53. This configuration effectively channels the wind between the solar panels 52 and support 53. The wind dissipates the heat energy given off by energy consuming devices, such as LEDs, so as to facilitate cooling or temperature control. In the absence of wind, the vanes 56 may be turned by motor 59 to facilitate cooling. FIG. 19 further shows a side view of the LED support 53, photodiodes or solar panels 52, wind screen or cover 55 and wind directional vane 57, Wind directional vane 57 operates in a manner similar to a weather vane in that it points in the wind direction. Wind directional vane 57 may be a variety of configurations The directional vane 57 and wind screen form an integral unit and are designed so the weight is evenly distributed each side of the axis of rotation, but the pointer can move freely on its axis. The area of the directional vane 57 is distributed so that the side with the larger area is blown away from the wind direction. The optional directional pointer may be mounted such that is always on the smaller side. For the wind direction reading to be accurate, the directional vane must be located well above the ground and away from buildings, trees, and other objects which interfere with the true wind direction. But the same is not necessary for the basic functioning of the assembly 50B.

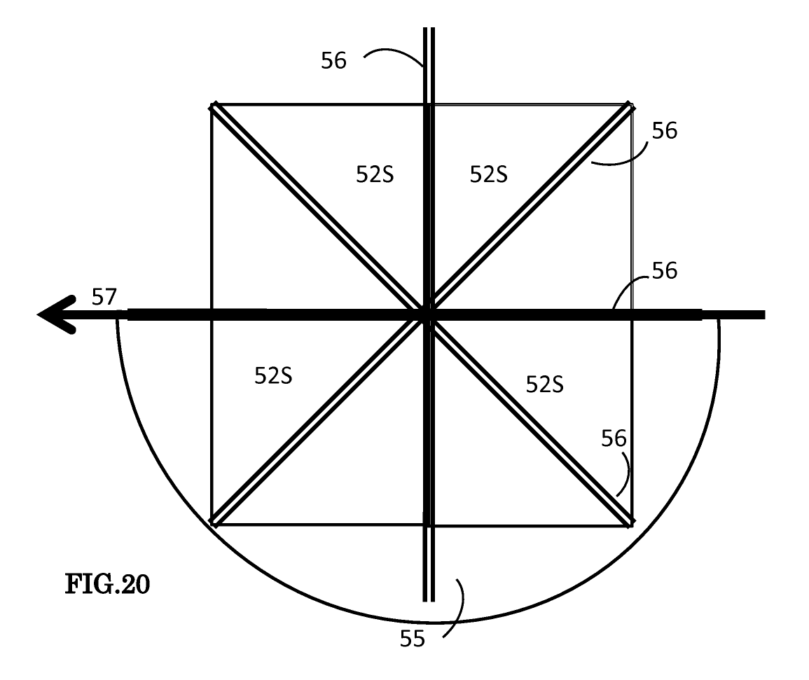

Shown in FIG. 20 is a plan view of a preferred embodiment energy supplying source for the traffic monitoring system. As shown in FIG. 20, for a prevailing wind direction from right to left (as shown in the Figure) the wind direction detector 57 would point to the left and the cover 5 would cover half of the vanes 56 so that the support 52 and the support 53 would turn in a counterclockwise direction on central portion 54. Central portion 54 may be a shaft which is operatively connected to shaft 61 and motor/generator 59. Although four vanes (or eight vane segments are shown in FIG. 20, any number of vanes could be used to enable the wind to propel or rotate the subassembly.

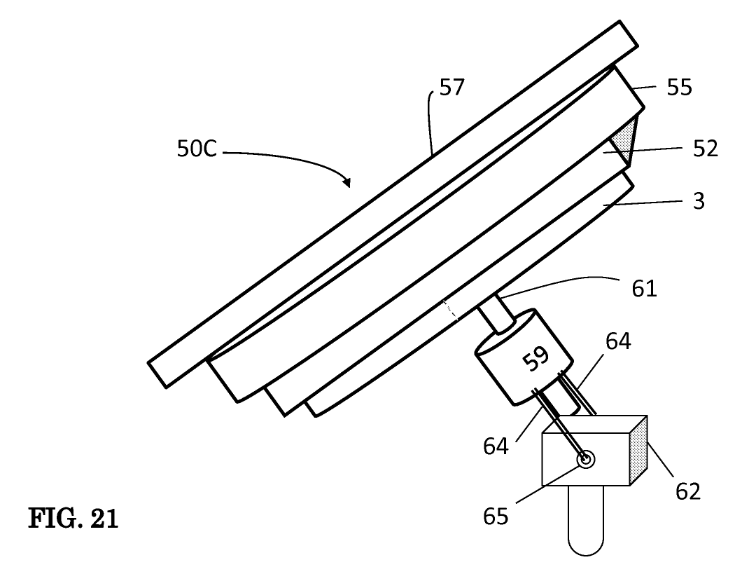

FIG. 21 is a schematic side view of a preferred embodiment energy supplying source for the traffic monitoring system in which assembly 50C comprises support 53, solar panels 52, cover 55, and wind direction vane 57. Motor-generator 59 is pivotally mounted by supports 64. Each of supports 64 are attached to a pivot or shaft or pivot 65. Shaft or pivot 65 is in turn driven by a motor inside housing 62 (as described further in U.S. Pat. No. 7,789,524) which causes the entire assembly 50C to pivot as shown in FIG. 21. As a result the solar support 52 and elements 52S on the assembly 50C can track the sun as it rises in the east and sets in the west. For example, a motor 66 slowly turns the pulley which drives the belt resulting in the angular disposition of the elements 52S.

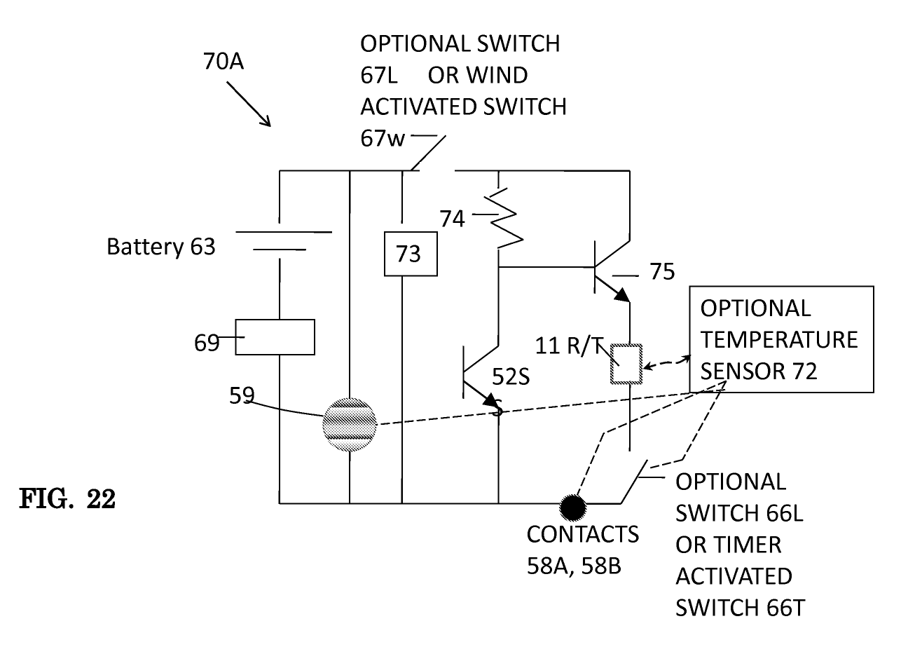

FIG. 22 is a schematic diagram showing a device 69 for regulating the voltage, controlling the charge into, and/or current from the battery 63 which also may optionally function as an on/off switch which prevents overcharging of the battery 63 and/or effectively removes battery 63 from the circuit 70A. Motor generator 59 operates to recharge battery 63 when in the generator mode and when a low battery indicator 73 indicates the need for a charge. The motor/generator 9 is optional in that the solar diodes may optionally be the sole means for recharging the battery 63. Also, when the motor/generator 59 is operating in the circuit 70A, in cases where the wind is causing the rotation of the vanes 56, the battery may be bypassed using device 69 to disconnect the battery from the circuitry entirely. Similarly, a device 69A may optionally be position in series with the motor/generator 59 to disconnect it from the circuitry when desired. As a further option, devices 69 and 69A may be combined into a combined voltage regulator, charge controller and/or charge level indicator. When the battery is determined to be low, (from optional low battery indicator 73 or the function could be incorporated into the power controller/regulator 69) the contacts 58A, 58B may be positioned such that the contacts are only intermittently connected to create a strobe-like effect and/or modulation for the activation of the elements 11R/T. Similarly, temperature sensor 72 may be operatively connected to the contacts 58A, 58B shorten the contact duration through contacts 58A, 58B or optionally may operate to open the optional switch 66L to prevent over heating of the energy consuming devices, such as 11-12, 11R/T, 12R, and/or activate motor/generator 59 to rotate the support 53 to create a cooling effect. Moreover, alternatively the light detector 75 (such as commonly used part 2N3904) may operate to turns the elements 11-12, 11R/T, 12R on and off at daylight and dusk either by sensing the intensity of light from the sun and/or environment or by a timer which turns the elements 11R/T on and off at specified times and also be responsive to the temperature sensor. Since congested traffic conditions occur mainly during rush hours or daily commuting times (6:30 AM to 9:30 AM and 3:30 PM to 6:30 PM) the system may be turned off at other times to conserve energy.

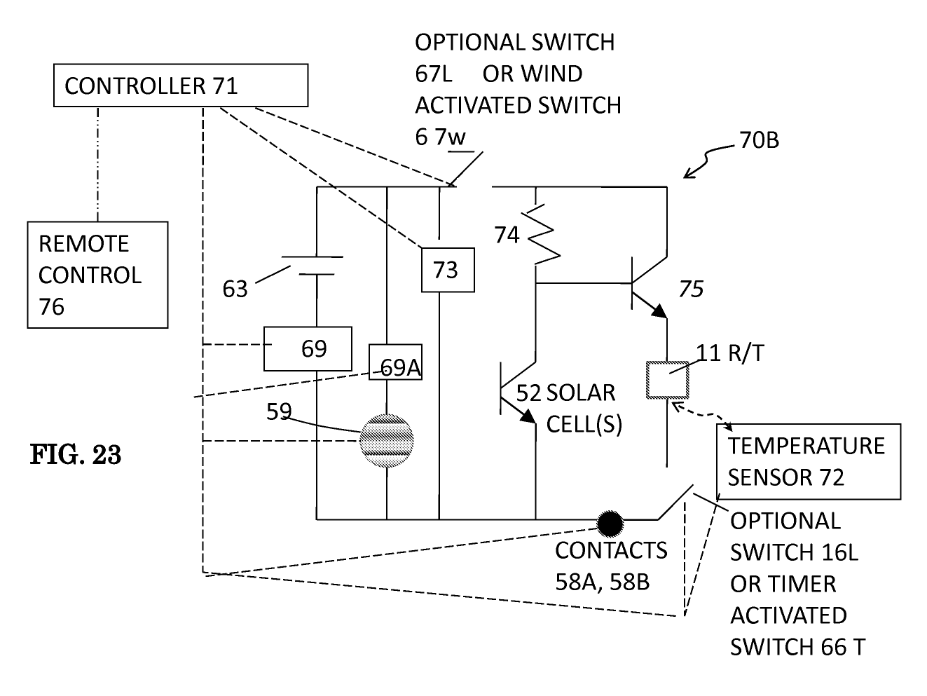

FIG. 23 is a schematic diagram showing circuitry 70B comprising an optional controller 71, with control lines represented by dashed lines. Controller 71 may be a microprocessor, programmable controller, processor, programmable chip device, computer, microcomputer, controller or the like. Controller 71 may receive control signals from the low battery indicator 73 and, in turn, regulate the contacts 58A, 58B such that the contacts are only intermittently connected to create a strobe-like effect for the activation of the energy consuming device, such as elements 11R/T. Similarly, if temperature sensor 72 sends a high temperature control signal to the controller 71, controller 71 may send control signals via the control lines to any one of or in tandem open the optional switch 66L to prevent over heating of the LED, activate motor/generator 59 to rotate the support 53 to create a cooling effect, and/or shorten the contact duration through contacts 58A, 58B. Moreover, alternatively controller 71 may have a light detector which turns traffic detectors 11R/T (as shown in FIGS. 1-7) on and off at daylight and dusk either by sensing the intensity of light from the sun and/or environment or by a timer which turns the energy consuming device on and off at specified times. Moreover the controller 71 may be a programmable controller includes a feedback routine for measuring the intensities of the energy consuming device and using the actual intensities as feedback. Optionally, the controller may cause the energy consuming device to be supplied with approximately 50% of said maximum current capacity or some fraction thereof to either conserve power or reduce the temperature of the energy consuming device. Optionally, the programmable controller may operate to adjust the intensity, with the programmable controller including an intensity compensation routine for adjusting the intensity of the energy consuming device, based on the intensity as detected by feedback means.

As used herein, the transmitter/receivers 11-12, 11R/T, 12R are interchangeable in that they are all detectors. The terminology detectors in the following claims refer to these transmitter/receivers as well as similarly functioning detectors.

As used herein the geographical orientation means the vehicle orientation in terms of traveling north, east, west or south or combinations thereof.

As used herein the terminology “idly” means at a slow speed or out of gear (neutral).

As used herein the terminology “processor” or “controller” as used herein may be a microprocessor, computer, programmable controller, programmable chip, multiprocessor, personal computer, CPU, coprocessor, central processor, or the like.

As used herein the terminology “external” means external to the vehicle.

Embodiments of the present invention are described herein are schematic illustrations of idealized embodiments of the present invention. As such, variations from the shapes of the illustrations as a result, for example, of manufacturing techniques and/or tolerances, are to be expected. The embodiments of the present invention should not be construed as limited to the particular shapes of displays illustrated herein but are to include deviations in shapes that result, for example, from manufacturing. The regions (or display areas) illustrated in the figures are schematic in nature and their shapes are not intended to illustrate the precise shape of a region and are not intended to limit the scope of the present invention.

As used herein, the terminology “transmitter receiver” or “transmitter-receiver” means an assembly or combination of assemblies which receive and transmit electromagnetic signals.

As used herein, the terminology “roadway” means street, road, highway, expressway, freeway or the equivalent.

Although a few exemplary embodiments of the present invention have been shown and described, it would be appreciated by those skilled in the art that changes may be made in these embodiments, without departing from the principles and spirit of the invention, the scope of which is defined in the claims and their equivalents.

1. A system for monitoring the flow of vehicular traffic comprising:
a plurality of detectors that detect the passage of a vehicle along a predetermined roadway; the detectors being powered by one of solar or wind power;
at least one transmitter for transmitting the data relating to the passage of a vehicle at a predetermined point on a roadway; the transmitter being powered by solar or wind power; and
a second receiver for receiving the transmitted data relating to the passage of a vehicle along a predetermined roadway for use by a motorist in determining a route of travel.

2. The system of claim 1 wherein the plurality of detectors operate to detect vehicular speed and are spaced at predetermined intervals along a roadway.

3. The system of claim 1 wherein the plurality of detectors comprise radar transmitter/receivers which are spaced apart at predetermined intervals along a roadway within each section of a limited access highway so that motorists may exit the limited access highway based upon the information relayed at an exit preceding the point in the limited access highway and wherein the information obtained by the radar transmitter/receivers is relayed to motorists navigating in the nearby region.

4. The system of claim 1 wherein the at least one transmitter is operatively connected to a GPS receiver and wherein the data relating to the passage of a vehicle is used to determine average traffic speed on a predetermined route and wherein the GPS receiver determines the suggested route for navigation based upon the average traffic speeds at the recorded points on a roadway or roadways.

5. The system of claim 1 wherein the at least one transmitter transmits at a radio frequency for reception by a motorist in the vicinity of the transmitter, and wherein the signal strength of the radio transmission is selected to be localized so that reception is limited to motorists traveling in the local region.

6. The system of claim 1 wherein the at least one transmitter is operatively connected to a display for displaying traffic speeds at points along a roadway.

7. The system of claim 1 further comprising a first processor, the plurality of detectors being operatively connected to the first processor, the first processor operating to determine an average speed for vehicles at a predetermined point in the roadway.

8. The system of claim 7 wherein the first processor is operatively associated with the at least one transmitter and wherein the at least one transmitter transmits average speed data to one of a GPS device, a radio broadcaster system, or a display for vehicles positioned along the same highway at a position prior to the predetermined point so that a vehicle approaching the predetermined point on the given roadway will have an option to take an alternate route depending upon the data reported.

9. The system of claim 7 wherein the at least one transmitter transmits to a second receiver which is located at a point remote from the predetermined point and wherein the second receiver is operatively connected to a second processor which determines average traffic speed at intervals along a roadway, the second processor being operatively connected to one of a GPS system, radio transmission, or display in the vicinity of the roadway having the predetermined point thereon.

10. A method for monitoring the flow of vehicular traffic for purposes of determining a route of travel for motorists comprising:
determining traffic speed at least one point along a roadway using a plurality of detectors that detect the passage of a vehicle; the detectors being powered by one of solar or wind power, and
transmitting the traffic speed using at least one solar powered transmitter for use by motorists in determining whether or not to select passage along the roadway containing the at least one point as a way to navigate through the region.

11. The method of claim 10 wherein the plurality of detectors comprise a plurality of first transmitter receivers spaced at intervals along a roadway for detecting the speed of a vehicles passing in the vicinity of the first transmitter receivers.

12. The method of claim 10 wherein the plurality of detectors comprise a plurality of radar transmitter/receivers and wherein the radar transmitter/receivers are spaced apart at intervals exceeding five hundred feet so as to monitor the traffic on a roadway and wherein the information obtained by the radar transmitter/receivers is relayed to motorists navigating in the nearby region.

13. The method of claim 10 wherein the at least one solar powered transmitter is operatively connected to a GPS receiver and wherein the data relating to the passage of a vehicle is used to determine average traffic speed on a predetermined route and wherein the GPS receiver determines the suggested route for navigation based upon the average traffic speeds at the recorded points on a roadway or roadways.

14. The method of claim 10 wherein the at least one solar powered transmitter transmits at a radio frequency for reception by a motorist in the vicinity of the at least one solar powered transmitter, and wherein the signal strength of the radio transmission is selected to be localized so that reception is limited to motorists traveling in the local region.

15. The method of claim 10 wherein the at least one solar powered transmitter is operatively connected to a display for displaying traffic speeds at points along a roadway.

16. The method of claim 10 further comprising a first processor, the plurality of detectors being operatively connected to the first processor, the first processor operating to determine an average speed for vehicles at a predetermined point in the roadway.

17. The method of claim 16 wherein the first processor is operatively associated with the at least one solar powered transmitter and wherein the at least one solar powered transmitter transmits average speed data to one of a GPS device, a radio broadcaster system, or a display for vehicles positioned along the same highway at a position prior to the predetermined point so that a vehicle approaching the predetermined point on the given roadway will have an option to take an alternate route depending upon the data reported.

18. The method of claim 10 wherein the at least one solar powered transmitter transmits to a second receiver which is located at a point remote from the predetermined point and wherein the second receiver is operatively connected to a second processor which determines average traffic speed at intervals along a roadway, the second processor being operatively connected to one of a GPS system, radio transmission, or display in the vicinity of the roadway having the predetermined point thereon.

19. A system for relaying information concerning flow of vehicular traffic along a roadway for use by persons traveling the roadway comprising:
at least one solar powered transmitter/receiver that detects the passage of a vehicle;
at least one solar powered transmitter for transmitting the data relating to the passage of a vehicle at a predetermined point on a roadway for use by motorists in determining a route of travel.

20. The system of claim 19 further including recording apparatus for recording information on one of accidents, obstructions, construction work or hazards for transmission to motorists operating along the roadway at a point prior to the section of the roadway that the recorded information concerns.
